(19) United States
(12) Patent Application Publication
(10) Pub. No.: US 2001/0012138 A1
(43) Pub. Date: Aug. 9, 2001

(54) Grating processing unit

(76) Inventors: Atsushi Sugitatsu, Tokyo (JP); Hiroyuki Kawano, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/784,036

(22) Filed: Feb. 16, 2001

Related U.S. Application Data
(63) Continuation of application No. PCT/JP00/04049, filed on Jun. 21, 2000.

(30) Foreign Application Priority Data
Jun. 22, 1999 (JP) 11-175838
Nov. 29, 1999 (JP) 11-337058

(51) Int. Cl. G02B 6/34; G03H 1/16; G02B 5/32

(52) U.S. Cl. 359/15; 359/29; 385/37

(57) ABSTRACT

Light emitted from a light source is split into a plurality of grating-like diverged beams of light by a Fourier transform phase hologram (3), and an image of a grating (100) is formed on a fiber (1) by a lens (4). Consequently, a grating cycle A can be obtained with accuracy ranging approximately from 25 to 1 (nm). Also, the grating cycle Λ can be readily changed.

### TECHNICAL FIELD

The present invention relates to a refractive index grating processing unit of an optical device (wave guide grating, fiber grating).

### BACKGROUND ART

FIG. 16 is an explanatory view of a conventional wave guide grating or fiber grating processing unit disclosed in, for example, Japanese Patent Application Laid-open (JP-A) No. 9-311238. In the drawing, Numeral 1 denotes an optical fiber (hereinafter, referred to simply as fiber) as a processing material whose unillustrated core portion is made of SiO₂ with addition of a few percent of GeO₂ that readily induces a change of a refractive index by means of light irradiation. Numeral 2 denotes beams of irradiation light irradiated for applying processing, Numeral 12 denotes an exposure mask having various characteristics used specifically for the kind (purpose) of processing, and Numeral 13 denotes an optical system (for example, a lens) for transferring a light distribution on the exposure mask 12 onto the fiber 1.

For example, if a mask that yields a grating-like light intensity distribution is used as the exposure mask 12, the beams of irradiation light 2 having passed through the exposure mask 12 are modulated into a grating-like intensity distribution. If a reduction transferring lens or the like is used as the optical system 13, grating-like beams of light in a desired dimension are irradiated to the fiber 1, and a refractive index of the fiber 1 changes selectively only where irradiated by the beams of irradiation light in the core portion addedwith GeO₂, whereby agrating corresponding to the grating-like light intensity distribution is formed.

Optical performances of the grating manufactured in the above manner largely depend on dimensional accuracy of the formed grating cycle. For example, the grating cycle A of the optical device called as a long-cycle fiber grating ranges from tens to hundreds (μm), and a proportional relationship expressed by an approximation (Λ) below is established between the grating cycle A and the center wavelength λ used for the device. The wavelength λ is in the vicinity of 1.55 (μm) for a communication optical device.

λ≈(Δn+δn)Λ (A)

Here, Δn is a difference between effective refractive indexes of unillustrated core portion and clad portion of the fiber 1, and δn is a quantity of a change of the refractive index selectively caused in the core portion by means of irradiation of beams of irradiation light. Typical example values of a difference the effective refractive indexes and the quantity of a change of the refractive index are approximately 5×10⁻³ and 1×10⁻⁴, respectively. Also, the entire length of the grating forming portion in the cycle direction as a typical size ranges approximately from 20 to 60 (mm).

Manufacturing accuracy of approximately ±100 (nm) is given to the general exposure mask 12. Thus, given ¼ as the transfer magnification of the reduction transferring lens used as the optical system 13, then the accuracy of the grating cycle Λ in the processing portion is calculated as:

±100 (nm)×¼=±25 (nm)

By substituting 25 (nm) into Λ in Equation (A), the accuracy of λ is found as ±0.13 (nm).

As has been discussed, the wavelength λ is in the vicinity of 1.55 (μm) for a typical communication optical device. Thus, it is preferable that the accuracy is 0.1 (nm) or better. Further, there has been a need to use more than one wavelength having a wavelength interval of 1 (nm) or less. Hence, to this end, high accuracy has been also demanded.

As has been discussed above, however, there is a problem that the conversion accuracy of the fiber grating manufactured by the conventional method is unsatisfactorily 0.13 (nm).

Also, the future trend shows that even higher accuracy is demanded for the wavelength λ, but there is a problem that neither can improvements of accuracy be expected from the conventional grating manufacturing method, nor the expected demand of even higher accuracy can be satisfied.

In addition, it is required to manufacture arbitrarily an optical device with the center wavelength λ of approximately 1.55 (μm)±0.3 (μm). However, according to the conventional method, the wavelength can be changed only in the cycle that is determined by the exposure mask prepared beforehand, thereby making it difficult to change the wavelength flexibly.

Further, in case that a grating longer than the typical laser beam size of 30 (mm), for example, the one having the length of 50 (mm) or 100 (mm) is necessary, the processing has to be applied while moving a laser beam and a work portion (exposuremask, optical system, etc.) alongthe optical axial direction of the fiber. However, there arises a problem that such moving further deteriorates accuracy.

Therefore, the present invention has an object to provide a grating processing unit capable of obtaining the grating cycle Λ with accuracy ranging approximately from 25 to 1 (nm).

The present invention has another object to provide a grating processing unit capable of readily changing the grating cycle Λ.

The present invention has a further object to provide a grating processing unit, in which the work portion does not have to be moved when processing a grating of a larger size.

### DISCLOSURE OF THE INVENTION

A grating processing unit of the present invention is a grating processing unit for forming a refractive index diffraction grating on a light wave guide, having a light wave guide portion using a material that causes a change of a refractive index by means of light irradiation, by irradiating irradiation light having a grating-like light intensity pattern, including: alight source; and an optical system for generating the irradiation light having the grating-like light intensity pattern out of light emitted from the light source through a Fourier transform phase hologram.

Also, the light wave guide is an optical fiber having a core portion using the material that causes a change of the refractive index by means of light irradiation.

Also, the optical system includes: a Fourier transform phase hologram having a function of diverging incident light emitted from the light source into a plurality of beams of outgoing light at an arbitrary predetermined angle; and a lens for forming an image of the plurality of beams of outgoing light from the Fourier transform phase hologram on the light wave guide.

Also, different intensity is given to each of the plurality of divergent beams of outgoing light. Also, each angle among the plurality of beams of outgoing light is equal. Also, each angle among the plurality of beams of outgoing light is different.

Also, the lens is a single lens provided between the Fourier transform phase hologram and light wave guide such that a position thereof is adjustable. Also, the lens is composed of a single lens and a cylindrical lens provided between the Fourier transform phase hologram and light wave guide such that a position thereof is adjustable.

Also, an axial direction of a cylinder of the cylindrical lens combined with the single lens is parallel with an axial direction of the light wave guide. Also, an axial direction of a cylinder of the cylindrical lens combined with the single lens intersects with an axial direction of the light wave guide at right angles and intersects with a line linking the light source and light wave guide at right angles. Also, the lens is a combined lens provided between the Fourier transform phase hologram and light wave guide such that a focal length thereof is adjustable.

Also, the combined lens is an fΘ lens arranged in such a manner that an incidence angle on the lens and an image position correspond linearly. Also, the combined lens has a cylindrical lens, and an axial direction of a cylinder of the cylindrical lens is parallel with an axial direction of the light wave guide. Also, the combined lens has a cylindrical lens, and an axial direction of a cylinder of the cylindrical lens intersects with an axial direction of the light wave guide at right angles.

Also, the Fourier transform phase hologram includes a rolling mechanism that is fixable at an arbitrary angle in-plane. Also, the Fourier transform phase hologram outputs beams of outgoing light having an arbitrary grating cycle in a plurality of different directions. Also, a pattern and a focal length of a lens of the Fourier transform phase hologram are determined in such a manner that divergent beams of outgoing light from the Fourier transform phase hologram have a uniform intensity distribution in a direction that intersects with a line linking the light source and light wave guide at right angles at a grating processing portion.

Also, the light source is a KrF excimer laser or an ArF excimer laser. Also, the light source is a carbon dioxide laser. Also, light beam adjusting means is provided between the light source and Fourier transform phase hologram to adjust a beam of light emitted from the light source into a shape that is determined by applying inverse Fourier transform to Fourier transform characteristics of the optical system.

Also, the light beam adjusting means uses a phase modulating element inserted between the light source and Fourier transform phase hologram. Also, the light beam adjusting means uses, as a light source, a laser oscillator for outputting a laser beam having a desired light beam distribution by modifying a resonator. Also, the light beam adjusting means is an aperture provided between the light source and Fourier transform phase hologram. Also, the light beam adjusting means adjusts the Fourier transform characteristics by displacing a position of the light wave guide forward or backward from an image forming position.

Also, the laser oscillator is additionally provided with a spectral band width narrowing device, so that wavelength purity of the light source is upgraded. Also, the optical fiber is displaced from a center position of an optical axis of the irradiation light to a position in a direction that intersects with a longitudinal direction of the fiber at right angles and intersects with the optical axis of the irradiation light at right angles. Also, the optical fiber is placed only atone side of abeam irradiation area from a center thereof.

Also, an interval between the Fourier transform phase hologram and lens is equal to a focal length of the lens. Also, the optical fiber includes: a light source connected to one end of the optical fiber; and a spectroscope, connected to the other end of the optical fiber, for measuring transmitting characteristics of a grating processed onto the optical fiber.

### BRIEF DESCRIPTION OF THE ACCOMPANYING DRAWINGS

FIG. 1 is a schematic view of a grating processing unit in accordance with a first embodiment of the present invention; FIG. 2 is an explanatory view of a distribution of an apodized grating; FIG. 3 is an explanatory view of a chirp refractive index grating; FIG. 4 is a schematic view of a grating processing unit of a seventh embodiment; FIG. 5 is a schematic view of a grating processing unit of an eighth embodiment; FIG. 6 is a schematic view of a grating processing unit of a ninth embodiment; FIG. 7 is a schematic view of a grating processing unit of a tenth embodiment; FIG. 8 is an explanatory view explaining an effect of the unit in FIG. 7; FIG. 9 is a view explaining an effect of a grating processing unit of the present invention; FIG. 10 is a schematic view of a grating processing unit in accordance with a thirteenth embodiment of the present invention; FIG. 11 is an explanatory view of characteristics explaining an effect of a grating processing unit of a fourteenth embodiment; FIG. 12 is an explanatory view of characteristics of the grating processing unit of the fourteenth embodiment; FIG. 13 is an explanatory view of an operation of a grating processing unit of a fifteenth embodiment; FIG. 14 is a view explaining a placement of a fiber for a grating processing unit of a sixteenth embodiment; FIG. 15 is a schematic view of a grating processing unit of an eighteenth embodiment; and FIG. 16 is a schematic view depicting an arrangement of a conventional grating processing unit.

### BEST MODE FOR CARRYING OUT THE INVENTION

The following description will describe in detail the present invention with reference to the accompanying drawings.

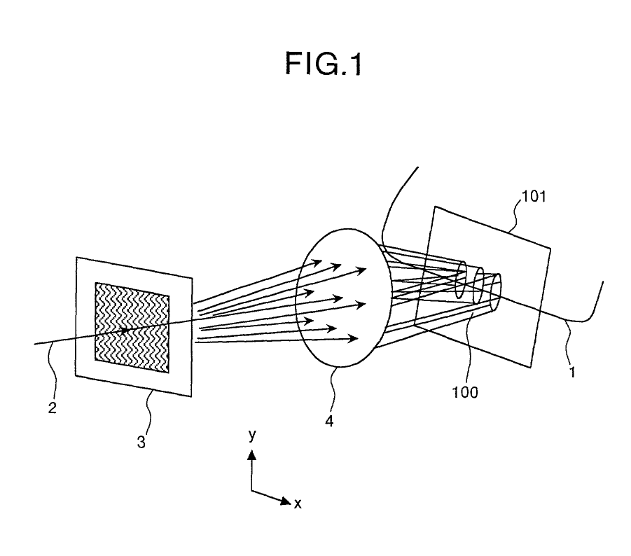

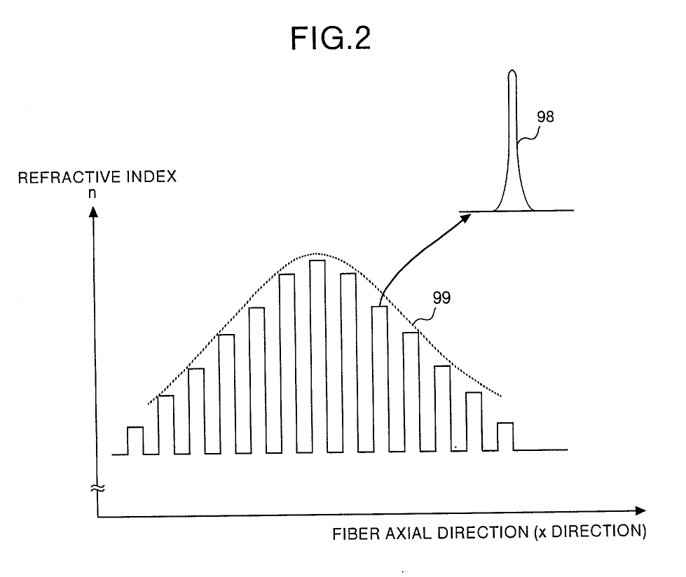

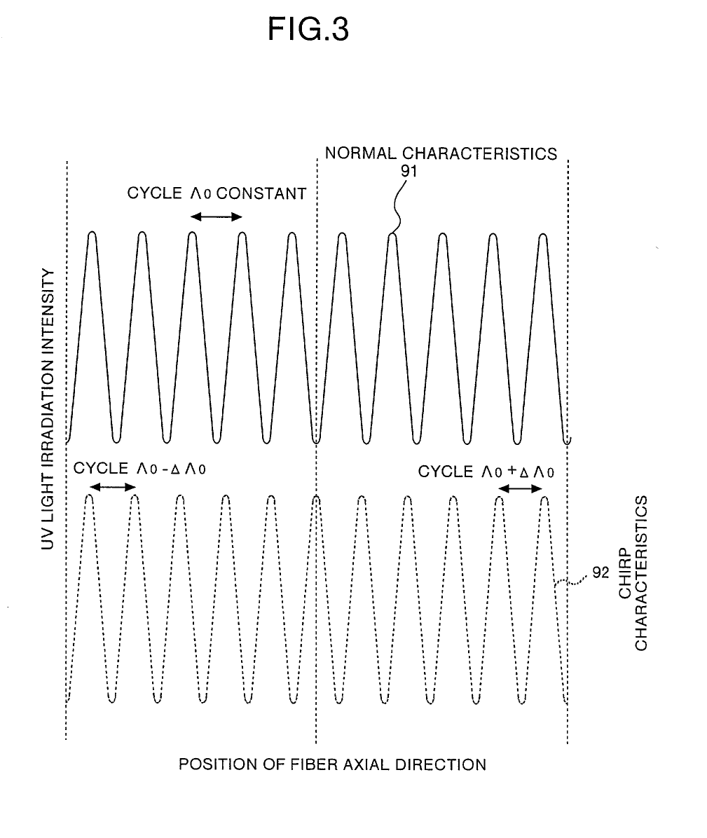

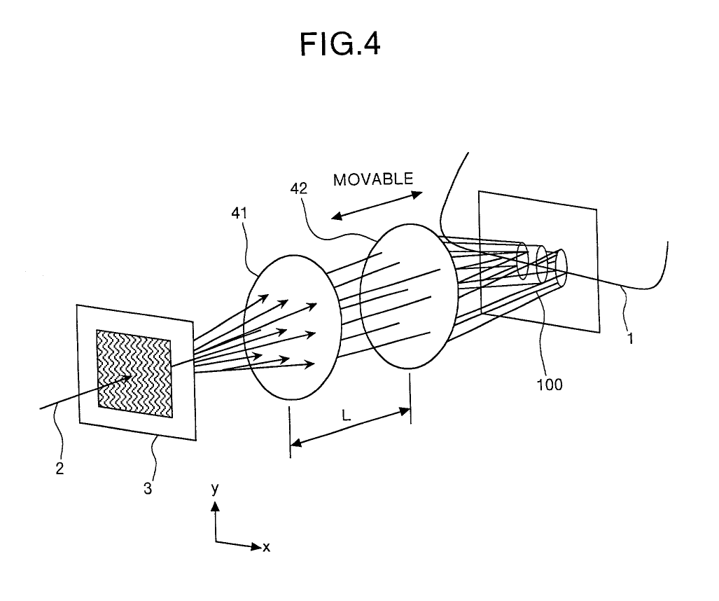

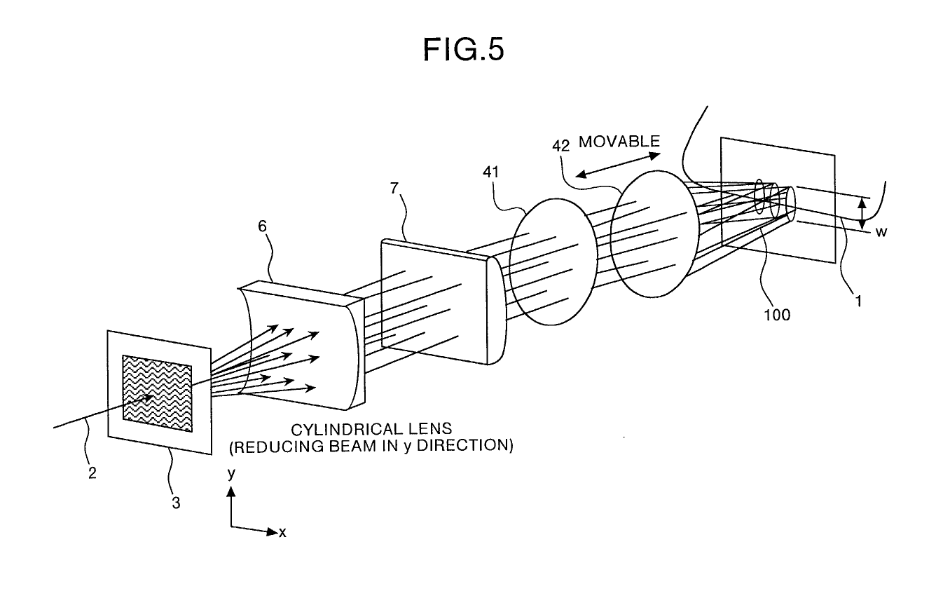

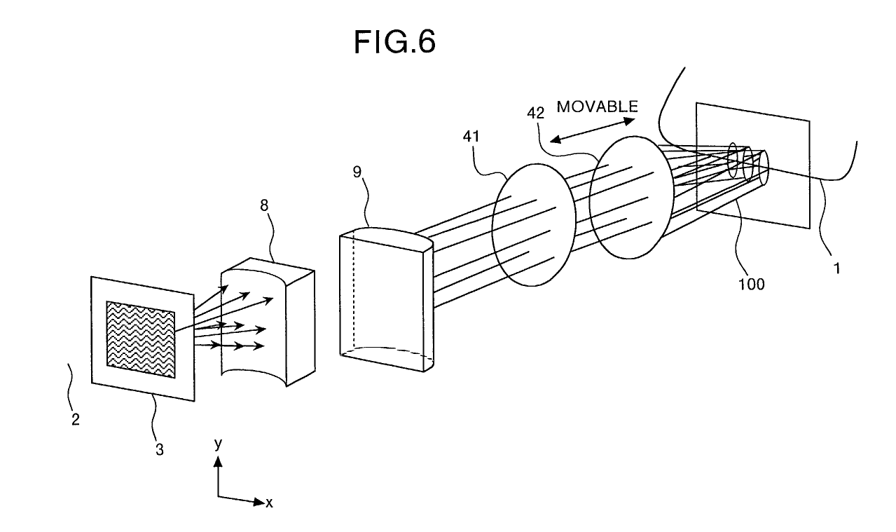

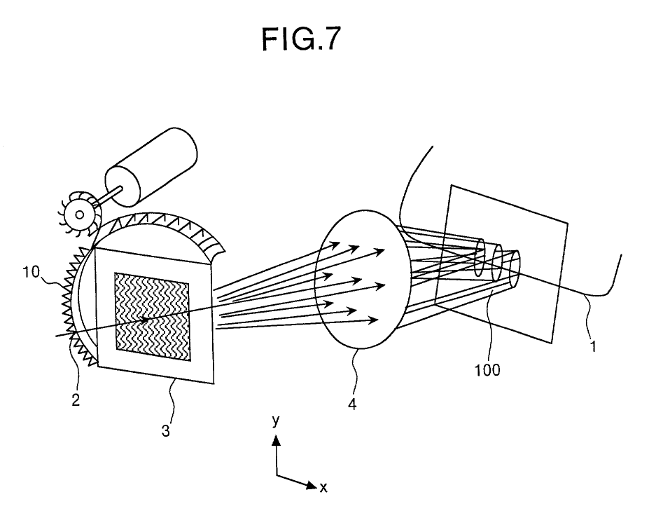

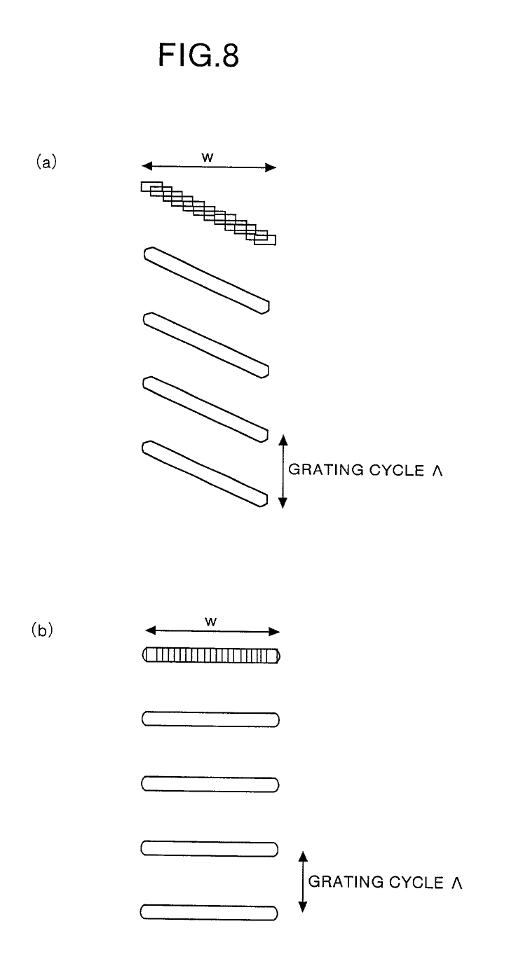

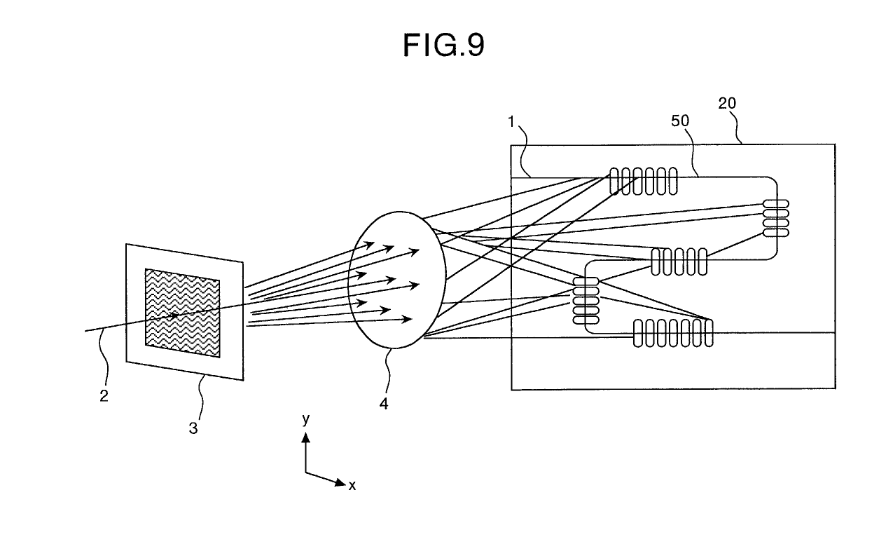

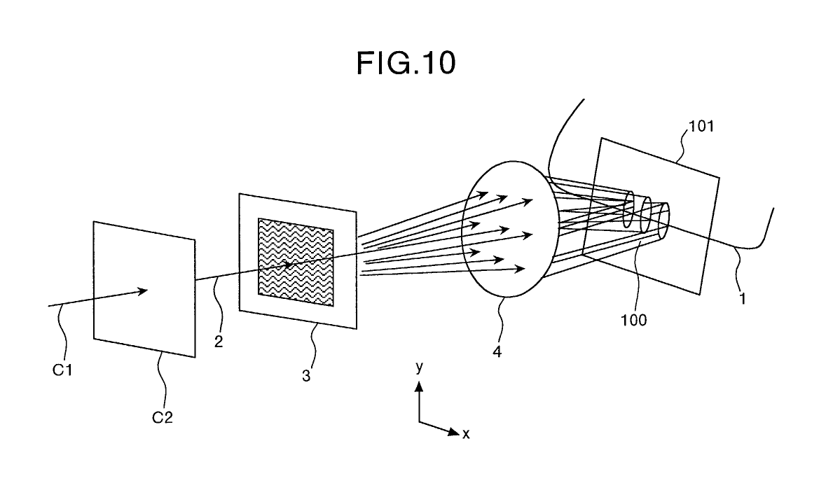

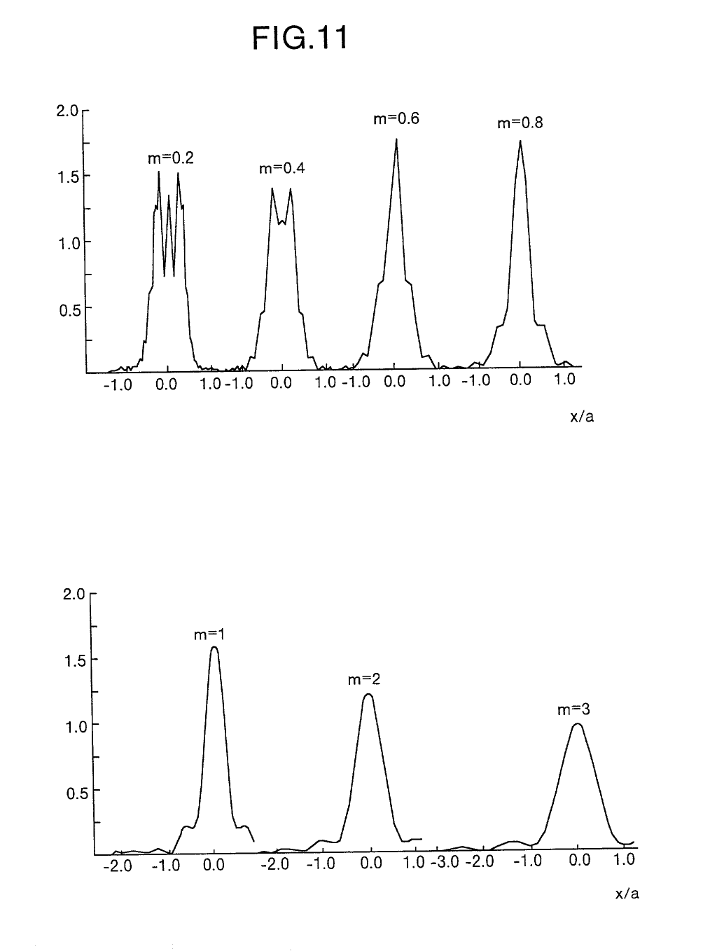

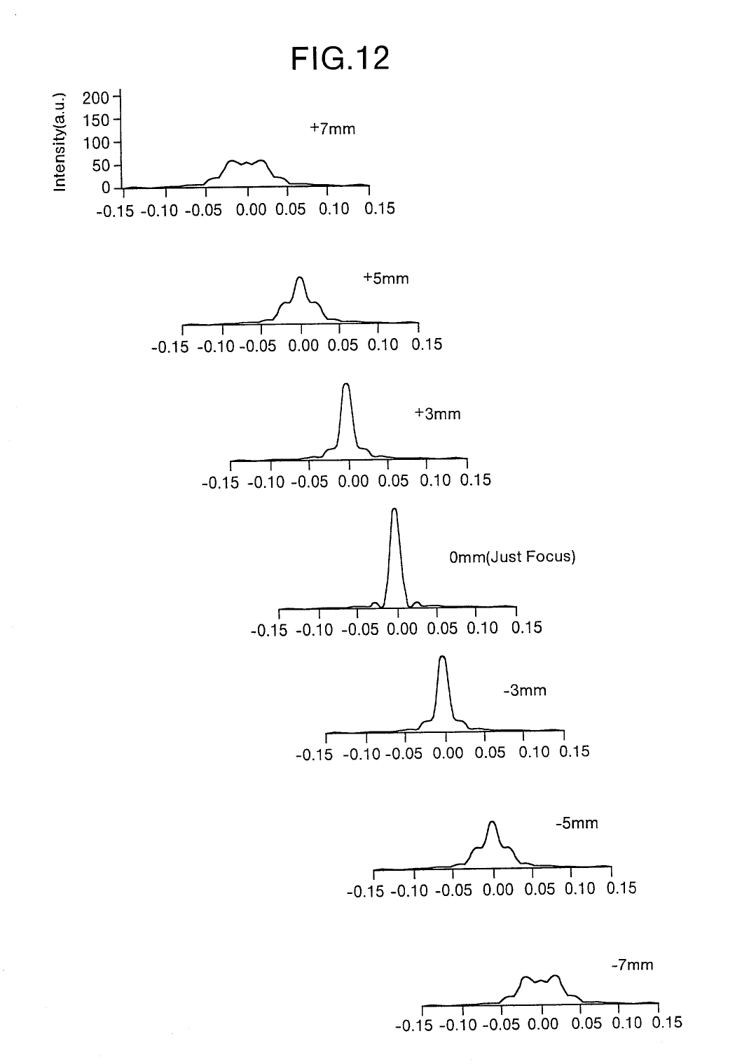

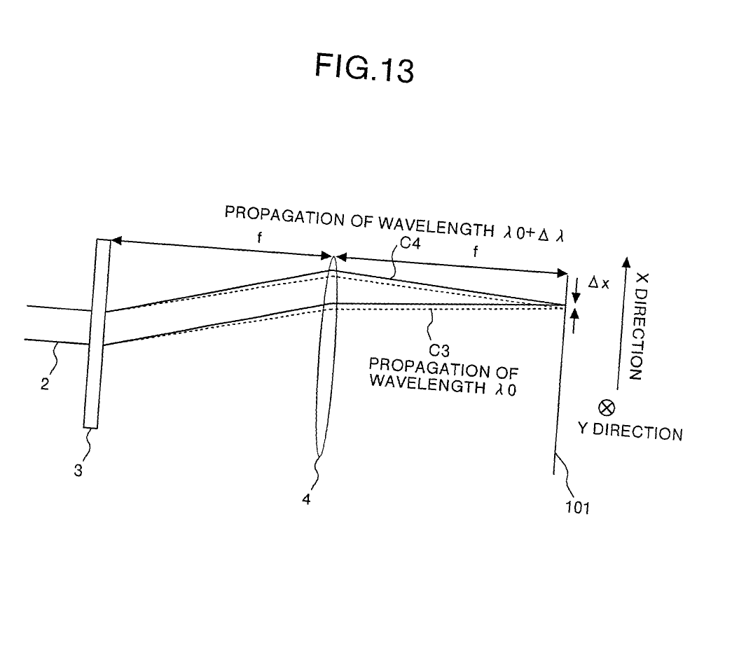

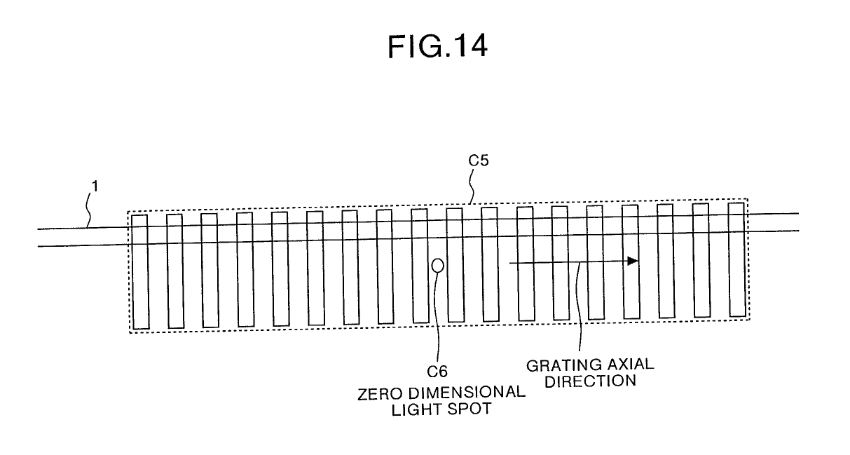

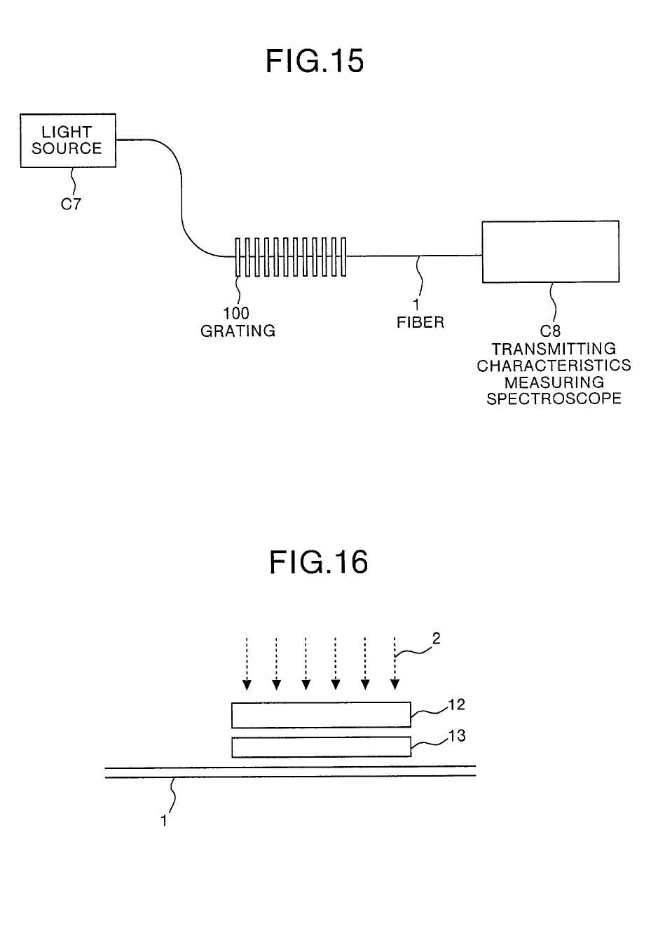

FIG. 1 shows a facility arrangement for carrying out a grating processing method in accordance with a first embodiment of the present invention. In the drawing, Numeral 1 denotes a fiber as a processing material (an optical fiber formed by using a material that causes a change of a refractive index by means of light irradiation in its core portion (light wave guide portion) and serving as one type of light wave guide), Numeral 2 denotes a beam of irradiation light for applying processing (although the details will be described below, it is, in principle, preferably a single beam of light such as a laser beam), and Numeral 3 denotes a Fourier transform phase hologram (also called as a holographic optical element (HOE), a diffracting optical element, a computer generated hologram (CGH), etc.). Numeral 4 denotes a single lens having a focal length of f (mm). The Fourier transform phase hologram 3, single lens 4, and fiber 1 are placed in parallel to each other. A distance between the Fourier transform phase hologram 3 and single lens 4 is f (mm) that corresponds to the focal length of the single lens 4, and a distance between the single lens 4 and fiber 1 is also f (mm) that corresponds to the focal length of the single lens 4. The Fourier transform phase hologram 3 and single lens 4 constitute an optical system.

As to the X-Y directions shown in the drawing, for ease of explanation, assume that, hereinafter, a capital letter X represents the axial direction of the fiber 1 that is parallel with the plane of the Fourier transform phase hologram 3, and a capital letter Y represents a direction that is parallel with the plane of the Fourier transform phase hologram 3 and intersects with the X direction at right angles. Numeral 101 denotes a screen illustrated only to explain how a grating 100 will appear for ease of explanation, and in practice, no components other than those holding the fiber 1 are necessary.

Details of the Fourier transform phase hologram 3 are given in, for example, W. H. Lee, “BinaryComputer-Generated Holograms”, Appl. Opt. 18, 3661 (1979), and omitted herein for ease of explanation. The Fourier transform phase hologram 3 is made of a material having resistance to UV rays and high transmittance, such as synthetic quartz, calcium fluoride, and magnesium fluoride, and a phase pattern corresponding to the wavelength of the beam of irradiation light 2 is formed on the surface.

In other words, given n as a refractive index of a material at the wavelength of the beam of irradiation light 2, and m as an integer equal to or greater than 2, then a concavo-convex pattern corresponding to 1/((n−1) m) of the wavelength of the beam of irradiation light 2 is formed on the surface in the depth direction, so that the beam of incident light 2 having passed through the Fourier transform phase hologram 3 goes out in any desired one dimensional or two dimensional direction by exploiting the interference effect. The concavo-concave pattern is formed in a one dimensional or two dimensional grating-like shape having regular intervals ranging from 0.1 to tens (μm). In case that the concavo-convex pattern is one dimensional in-plane, a grating-like light intensity distribution can be realized on the fiber 1 in the X direction alone by the optical system including the Fourier transform phase hologram 3. The principle underlying the formation of a grating-like distribution of the refractive index on the fiber 1 by means of the light intensity distribution is the same as the one in the conventional method, and the explanation is omitted herein. The one dimensional concavo-convex pattern is advantageous in that it can be readily manufactured at a lower cost.

For example, in case that the beam of irradiation light 2 is diverged into 60 beams of light at the interval of 1 mrad by the Fourier transform phase hologram 3, given 300 (mm) as the focal length f of the single lens 4, then the grating-like light intensity distribution having 60 lines with the grating cycle Λ=300 (μm) is realized on the fiber 1. As has been mentioned, because the Fourier transform phase hologram 3, single lens 4, and fiber 1 are placed by keeping a distance equal to the focal length f (mm) of the single lens 4 from each other, the beams of outgoing light that are diverged at regular angles by the Fourier transform phase hologram 3 are transferred and collected onto the fiber 1 at regular intervals.

According to the present embodiment, by merely preparing the single lens 4 having a large diameter, the grating processing covering a long range (a range corresponding to the diameter of the single lens 4) can be accomplished with a simple arrangement. Although it is not illustrated in the drawing, by using a stage that can move the processing fiber 1, the processing of the grating 100 larger than the maximum processing size by means of collective irradiation can be realized. As has been mentioned, the grating 100 in the arrangement shown in FIG. 1 is composed of 60 lines with an interval of 300 (μm). Hence, when manufacturing the grating 100 of 18 (mm) or larger, the fiber 1 only has to be moved along its axial direction.

The following description will describe an embodiment of the beam of irradiation light 2. As a light source, a UV rays lamp, such as a mercury lamp, an excimer laser or a wavelength transforming solid state laser as a UV laser, a carbon dioxide laser having an infrared wavelength that induces a change of a refractive index by a photo elasticity effect by means of stress relaxation, etc. can be used, and the explanation will be given by using the excimer laser as an example. The excimer laser has relatively low coherence as a laser, and for this reason, intensity is superimposed rather than the electric field amplitude is superimposed, which is advantageous in obtaining uniform intensity.

For example, in case that a KrF excimer laser (wavelength λ=248 (mm)) is used, if synthetic quartz (n=1.5) is used under the condition that the concavo-convex pattern on the surface in both the X and Y directions have 2 (μm) pitch and m=2, then a typical example of the Fourier transform phase hologram 3 would be a two-step phase type having a groove depth of 0.25 (μm). The concavo-convex pattern with 2 (μm) pitch is optimized by a computer, and in the example shown in FIG. 1, the Fourier transform phase hologram 3 diverges the beam of irradiation light 2 into 60 beams each spaced apart by 1 mrad in the X direction, and 100 beams each spaced apart by 0.2 mrad in the Y direction. Thus, given 300 (mm) as the focal length f of the single lens 4, then a grating-like uniform light intensity distribution having the grating cycle Λ=300 (μm) and 60 lines in the Y direction is realized.

In the foregoing arrangement, the beams diverged in the X direction and Y direction by the Fourier transform phase hologram 3 are collected on the fiber 1 with intervals of 300 (μm) and 60 (μm), respectively. Meanwhile, because the divergence angles of the KrF excimer laser emitting the beam of irradiation light 2 are approximately 0.5 mrad and 1 mrad, respectively, the beam expansions on the fiber 1 in the X direction and Y direction are 150 (μm) and 300 (μm), respectively. Consequently, a grating of the light intensity distribution is formed in the X direction and each divergent component is superimposed in a uniform manner in the Y direction.

Because the coherence is low when each component in the Y direction is superimposed (herein, the spatial coherence length is as short as 1/10-1/200 of the beam size), light hardly interferes with each other at the superimposed portion, and a simple sum of the irradiation intensity of each diverged beam of light is yielded, thereby making it possible to realize a smooth desired distribution shape. Such low coherence is the common characteristics in each excimer laser, such as ArF, XeCl, and F₂ excimer lasers, and the same can be said when any other excimer laser is used.

The light source referred to in the present invention includes an ion laser and a laser diode besides the foregoing mercury lamp, excimer laser, wavelength transforming solid state laser, and carbon dioxide laser.

FIG. 2 shows an intensity distribution to explain the distribution in the X direction of the entire grating and the distribution in the X direction of one line of the grating. In the drawing, Numeral 98 denotes an intensity distribution within each comb tooth portion of the comb teeth shape, and Numeral 99 denotes an envelope of the distribution in the X direction of the entire grating.

For an irradiation intensity distribution in the X direction for an image formed on the fiber 1 shown in FIG. 1, there are two points: the distribution in the X direction for each line of the grating, that is, the intensity distribution within each comb tooth portion in the comb teeth shape (denoted by Numeral 98 in FIG. 2), and the distribution in the X direction of the entire grating, that is, the intensity distribution within the teeth row of all the comb teeth (denoted by Numeral 99 in FIG. 2). The following description will describe, in the first place, the former, that is, the distribution 98 in the X direction of each line of the grating, that is, the intensity distribution within each comb tooth portion in the comb teeth shape. The latter will be explained in a fourth embodiment below.

The intensity distribution in the X direction on the image plane formed by the arrangement shown in FIG. 1 is basically the Fourier transform shape of the beam intensity distribution in the X direction of the beam of irradiation light 2. Hence, in case that the intensity distribution 98 in the X direction is formed by one divergent beam of light, for example, if the beam of incident light 2 on the Fourier transform phase hologram 3 has a Gaussian intensity distribution, a Gaussian distribution of that Fourier transform shape can be realized. On the other hand, in order to form a shape different from the Fourier transform shape of the beam of incident light 2, the one dimensional concavo-convex pattern in the X direction of the Fourier transform phase hologram 3 is changed, so that the grating of one light intensity distribution is formed by superimposing a plurality of divergent beams of light. Consequently, the intensity distribution 98 in the X direction of one comb tooth can be shaped in any desired intensity distribution shape in the X direction, for example, in wave forms, such as a rectangular wave, a sine wave, a Gaussian wave, and a triangular wave.

As to the adjustment of the intensity distribution in the X direction explained in the second embodiment, if the concavo-convex pattern of the Fourier transform phase hologram 3 is formed in two dimensions, the same can be said in the Y direction. However, in case that the processing material is the one dimensional fiber 1 as shown in FIG. 1, it is often preferable to provide a uniform range a few to hundreds times grater than the thickness of the fiber 1 in the intensity distribution in the Y direction, because a larger margin is allowed for the placing position of the fiber 1. Also, placing more than one fiber is advantageous in that they can be processed simultaneously. Alternatively, by adjusting the two dimensional concavo-convex pattern of the Fourier transform phase hologram 3, the Fourier transform phase hologram 3 may be used as a homogenizer that makes the intensity distribution in the Y direction uniform across a certain width.

As to the distribution in the X direction of the entire grating, that is, the intensity distribution within the teeth row of all the comb teeth, the envelope (denoted by Numeral 99 in FIG. 2) of the intensity is adjusted in the same manner as the intensity distribution (denoted by Numeral 98 in FIG. 2) within one tooth in the comb teeth explained in the second embodiment. For example, if the concavo-convex pattern of the Fourier transform phase hologram 3 is formed in such a manner that the number of beams of light that are superimposed on the fiber 1 is reduced with increasing differences in an angle of the beams of outgoing light with respect to the incident optical axis, the envelop intensity distribution is shaped into the Gaussian distribution. Then, the intensity distribution of the light grating on the fiber 1 can manufacture a refractive index grating, in which the grating cycle Λ is constant as shown by the envelope 99 in FIG. 2, but the envelope of the entire intensity follows the Gaussian distribution. The apodization is not limited to the Gaussian shape, and can be any intensity distribution envelope, such as a sine wave, a triangular wave, and a rectangular wave.

In the refractive index grating manufactured by the method of the first embodiment, by changing the one dimensional concavo-convex pattern in the X direction of the Fourier transform phase hologram, the pitch between the comb teeth in the X direction that forms the grating can be varied slightly (a so-called chirp can be formed) instead of being made regular. More specifically, the pitch between the comb teeth can be varied slightly by forming the one dimensional concavo-convex pattern in the X direction of the Fourier transform phase hologram 3 on the image plane with a large space cycle having a 10 (μm) pitch, for example, and arranging in such a manner that the concavo-convex pattern serves as the negative interference and cancels out the cycle with the interval ranging from 10 to 260 (μm) in a satisfactory manner so as not to appear, while serving as the positive interference to form the cycle with an interval ranging from 270 (μm) to 330 (μm) per 10 (μm) on the image plane.

For example, the grating having regular intervals of 300 (μm) is changed to a series of gratings that cyclically change sequentially from 270 (μm) to 330 (μm). FIG. 3 is a schematic view showing a light intensity distribution to explain a light intensity distribution state 92 of a chirp grating together with a light intensity distribution 91 of the grating having regular intervals. In the state 92 of the chirp grating, the cycle at the left end and the cycle at the right end in the drawing are different. Such a change in cycle is produced sequentially from the left end to the right end in the drawing.

Consequently, the wave guide grating or fiber grating thus manufactured can attain filter characteristics different from those of the sine/cosine function type by the normal grating with regular intervals.

In the first embodiment shown in FIG. 1, by changing the interval f between the Fourier transform phase hologram 3 and single lens 4, and the interval f between the single lens 4 and fiber 1 simultaneously within a range of a few percent of f in the same manner, the grating cycle Λ to be formed can be varied by a few percent. A change grater than a few percent makes it impossible to obtain satisfactory result, because the aberration of the single lens 4 becomes too large.

If the grating cycle needs to be increased by the method of changing the position of the single lens 4 or the like, the grating cycle can be increased by changing the focal length f of the single lens 4, and then changing the interval between the Fourier transform phase hologram 3 and single lens 4, and the interval between the single lens 4 and fiber 1.

With the first embodiment shown in FIG. 1, a UV laser beam is used as the beam of irradiation light 2 in most of the cases, and the single lens 4 is generally a quartz lens useful for UV rays. Also, the quartz lens is used as a single lens in many cases for the reason of the cost. It should be appreciated, however, that the single lens 4 is not necessarily used, and a grating with even higher accuracy can be formed by using a combined lens including the single lens 4 or a so-called fΘ lens that is manufactured such that an incidence angle Θ on the lens and the image position correspond linearly.

FIG. 4 shows an example of a combined lens. In the drawing, Numerals 41 and 42 denote a combined lens, and each is composed of a quartz single lens having the same focal length f=540 (mm). The lens interval L is adjustable and can be adjusted in a range from 20 to 200 (mm), for example. In this case, given 1 mrad as the angle interval of the beams of outgoing light diverged by the Fourier transform phase hologram 3, then the grating cycle Λ can vary in a range from 270 to 325 (μm).

In addition, for example, by controlling the lens interval L by an electricity-driven stage or the like, the position accuracy can be control to approximately 1 (μm) The accuracy of the grating cycle Λ at this time is approximately 0.3 (nm), thereby making it possible to effect highly accurate control that no other method has ever succeeded.

According to the method explained in the seventh embodiment, the width W (illustrated in FIG. 5, the width in the Y direction) of the grating light intensity is determined by the performance of the Fourier transform phase hologram 3 and the lens (zoom lens set) composed of a combination of the single lenses 41 and 42, and at the same time, the grating cycle Λ is determined by the combination. Hence, if the grating cycle Λ is determined with the higher precedence, no margin is allowed for the zoom lens set 41 and 42 to adjust the grating light intensity or the width thereof.

FIG. 5 shows an arrangement that improves the foregoing conditions, so that the adjustment of the grating cycle by the lens and the adjustment of the light intensity by the lens are effected separately. In the drawing, Numerals 6 and 7 denote cylindrical lenses, which constitute a telescope system and are placed between the Fourier transform phase hologram 3 and the zoom lens set 41 in such a manner that the cylinders axes of the cylindrical lenses 6 and 7 are in the direction parallel with the axis of the fiber 1. In case of the present arrangement, given three times as the magnification of the telescope system 6 and 7, then the width (denoted by a capital letter W in the drawing) of the grating light intensity near the fiber 1 is reduced to ⅓ and the light intensity is increased by three times. On the other hand, the grating cycle Λ does not change, because the cylindrical lenses 6 and 7 do not work in any manner in the axis direction of the fiber 1.

According to the method shown in FIG. 5, by adjusting the magnification of the telescope system, the light irradiation intensity can be adjusted independently of the grating cycle Λ. Hence, by allowing a larger placing margin for the processing portion of the fiber 1 and collecting the irradiation light to a narrow range, there can be attained an effect that a plurality of fibers 1 aligned in parallel can be processed simultaneously by cutting the processing time shorter, or conversely, by replacing the telescope system 6 and 7 with an adequate lens to form a reducing system having a magnification of 1 or less. The telescope system 6 and 7 is illustrated with two lenses in the drawing. It should be appreciated, however, that adequate lenses of an arbitrary number can be used in response to the reducing or enlarging magnification to attain the similar effect. Although it is not shown in the drawing, the cylindrical lenses 6 and 7 may be combined with the single lens 4 explained in the first embodiment with reference to FIG. 1 instead of the combined lens 41 and 42.

Conversely to the eighth embodiment, it can be arranged in such a manner that the grating cycle A can be adjusted independently of the irradiation intensity. FIG. 6 shows an arrangement to achieve such an object. In the drawing, Numerals 8 and 9 denote cylindrical lenses, which constitute a telescope system and are placed between the Fourier transform phase hologram 3 and zoom lens set 41 in a direction (parallel to the Y direction) such that the cylinders axes of the cylindrical lenses 8 and 9 intersect with the axis of the fiber 1 at right angles. The grating cycle A can be adjusted independently of the light intensity by enlarging or reducing the size of the image formed on the fiber 1 with adjustment of the magnification of the telescope system. Here again, the telescope system 6 and 7 is illustrated with two lenses in the drawing. It should be appreciated, however, that adequate lenses of an arbitrary number can be used in response to the reducing or enlarging magnification to attain the similar effect.

FIG. 7 shows an arrangement of a grating processing unit in accordance with a tenth embodiment of the present invention. In the drawing, Numeral 10 denotes a rolling mechanism of the Fourier transform phase hologram 3, which is composed of a ring of rack that holds the Fourier transform phase hologram 3 and a pinion that rotates the gear, thereby allowing the Fourier transform phase hologram 3 to rotate in-plane by an arbitrary angle while fixing and holding the same.

The X-Y cross section of the beam of irradiation light 2 is matched with the X and Y angles directions of the beams of outgoing light by the Fourier transform phase hologram 3 by manipulating the rolling mechanism 10. For example, when a light source, such as an excimer laser, that has different divergence angles in the X direction and Y direction and the orientation at the cross section of the beam of light 2, if the X-Y cross section of the beam of irradiation light 2 is not matched with the X and Y angles directions of the beams of outgoing light by the Fourier transform phase hologram 3, a tilted grating as shown in FIG. 8(a) is formed. However, by matching the former and the latter with the rolling mechanism 10 shown in FIG. 7, a parallel grating as shown in FIG. 8(b) can be formed.

The following description will describe one of use examples of the grating processing unit of the present invention with reference to FIG. 9. As shown in FIG. 9, with respect to a light wave guide (a PLC, Planner Lightwave Circuit) 50 having a rectangular cross section and formed on a quartz substrate 20, the Fourier transform phase hologram 3 forms not a single irradiation portion, but a plurality of irradiation portions at arbitrary positions on the PLC 50 with a rectangle cross section. For example, a larger concavo-convex pattern cycle is given largely in each of the X direction and Y direction of the Fourier transform phase hologram 3 so as to correspond to the minimum pitch on the image plane in each direction. Then, by arranging in such a manner that the pattern of the unnecessary pitch on the image plane is cancelled out so that the cycle does not appear as the concavo-convex pattern negatively interferes with the same in a satisfactory manner, while a desired cycle on the image plane is generated as the concavo-convex pattern interferes positively. Consequently, a plurality of the grating-like irradiation portions can be formed at arbitrary positions on the PLC 50 having a rectangular cross section on the quartz substrate 20.

The fiber 1 includes a type that causes a significant change of the refractive index by means of stress besides the foregoing type that causes a significant change of the refractive index by means of light irradiation.

In case that the fiber 1 of the above type is used, in the arrangement explained in the first embodiment with reference to FIG. 1, by using the carbon dioxide laser as the light source, stress caused when manufacturing the fiber 1 or wave guide (not shown) can be thermally relaxed selectively at the laser irradiation portions alone, thereby making it possible to form the refractive index grating. Herein, the refractive index grating exploits the photo elasticity effect, by which the refractive index varies with the presence or absence of the stress, and is formed by placing an area where the stress is relaxed and an area where the stress is not relaxed alternately. Thus, the mechanism that induces a change of the refractive index is different from those of the foregoing embodiments.

In general, with the optical system to which paraxial approximation is adaptable, a Fourier transformed intensity distribution image goes out for an incidence light intensity distribution. In the first embodiment shown in FIG. 1, if the function of the phase hologram is not concerned, the optical system composed of three elements including (1) the lens 4, (2) a distance from the phase hologram 3 to the lens 4, and (3) a distance from the lens 4 to the processing plane 101 forms on the processing plane 101 a Fourier transformed intensity distribution for the intensity distribution of an incident beam of light on the phase hologram 3. By using the example in the first embodiment as an effect of the phase hologram, a Fourier transformed image composed of 60 divergent beams in the X directions and 100 divergent beams in the Y directions totaling 6000 divergent beams is formed on the processing plane 101.

Here, the adjacent divergent beams of light in the Y direction are superimposed on the processing plane 101, but the 60 divergent beams of light in the X direction directly form the comb portion of the grating 100. In other words, as to the X direction, the Fourier transformed intensity distribution of the incidence intensity distribution on the phase hologram 3 forms each comb portion of the grating 100, and irradiates the processing fiber 1. Thus, as shown in FIG. 10, the beam of light 2, which is arranged in such a manner so as to have a desired intensity distribution by allowing a beam of irradiation light C1 emitted from the light source to pass through an intensity modulating mask C2, is incident on the phase hologram 3, whereby the refractive index distribution in each comb of the refractive index grating that will be formed on the fiber 1 can be shaped in any desired shape on the processing plane 101.

More specifically, for example, in case of the beam of light 2 having a rectangular (top hat shape) of the intensity distribution in the X direction by the intensity modulating mask C2, the comb portion that irradiates the processing fiber 1 shapes an SINC function. Also, as another example, in case that the beam of light 2 is a triangular wave, the comb of the irradiation portion shapes SINC×SINC. The beam of light 2 does not have to be an intensity distribution expressed by an analytic function as has been discussed, and only an intensity distribution necessary for the beam of light 2 has to be found by means of inverse Fourier transform from a desired irradiation beam shape through a numerical analysis. Because the intensity modulating mask C2 has relatively low energy density compared with the processing portion, a typical intensity modulating mask (for example, Cr mask) may be used, but means of using a dielectric multi-layer mask having good resistance to light intensity and good long-term stability with respect to high energy density, or means of using a reflection mirror or an aperture is also available.

According to the arrangement shown in FIG. 10, the refractive index grating having a desired comb shape can be obtained by merely replacing the intensity modulating mask C2 without carrying out economically disadvantageous method of increasing the cycle of the concavo-concave pattern of the phase hologram 3 and widening the beam of incident light 2 accordingly. It should be noted, however, that, as has been discussed above, because the plane of the phase hologram 3 and the processing plane 101 have the Fourier transformation relationship, in order to add further minute modulation on the processing plane 101, the pattern of the corresponding size has to be formed on the phase hologram 3.

A similar effect can be attained if a desired intensity distribution in the X direction is obtained on the processing plane by making the intensity distribution and phase of the beam of incident light 2 in a predetermined state with the following: using the foregoing various means or lens, prism or the like (which are collectively refer to as the phase modulating element) instead of the intensity modulating mask C2; changing the laser resonator itself to an adequate stable resonator or unstable resonator; inserting the phase modulating element into the resonator, or combining the foregoing. The intensity modulating mask C2 is what is referred to as light beam adjusting means of the present invention.

More flexibility is given in forming a beam by providing an aperture for the beam of incident light C1 as means (light beam adjusting means) that changes the intensity distribution of the beam of light 2 irradiated to the hologram 3 into a desired shape, and letting the same go into the phase hologram 3 by changing the intensity distribution shape through diffraction. For example, FIG. 11 shows an actual example of a change of the intensity distribution by diffraction of the beam of incident light C1, and shows how a diffraction light intensity distribution changes with a propagation distance when parallel light goes into a slit of aperture with a width a. In this example representing the Fresnel diffraction, m is a coefficient representing the propagation distance, and a distance from the aperture is expressed by using the wavelength λ as: (m a²)/(2 λ). Given m=0.4, the aperture is almost a rectangle, and given m=2 or more, the aperture is almost a triangle.

Also, as another auxiliary means, a desired shape can be obtained by defocusing the position of the processing plane 101 (that is, the position of the optical fiber or light wave guide) forward or backward from the image forming position. For example, FIG. 12 shows a change of the shape of the beam intensity distribution by means of defocus of ±7 mm when a beam of incident light of a rectangular (top hat) intensity distribution is adapted to the optical system shown in FIG. 1. FIG. 12 reveals that slight defocusing can change the SINC function shape into an almost top hat shape.

In case of the excimer laser, an oscillating wavelength has a wide spectral bandwidth in general, and defocus caused by the spectral displacement, namely, so-called chromatic aberration, occurs on the processing plane as a result. For example, in case of a KrF excimer laser, the spectral half band width is approximately 0.4 nm (+0.2 nm) at broad band oscillation by a typical oscillator, and a difference of the refractive indexes of the corresponding synthetic quartz is approximately ±0.0001. This difference of the refractive indexes causes displacement in a refracting optical element including the phase hologram. Thus, by reducing the refractive indexes difference, there can be attained an effect that image accuracy can be upgraded, a larger margin is allowed for the vertical direction with respect to the processing plane, that is, the focal depth can be deeper, etc.

For example, because of different wavelengths, adverse effect as discussed below is given to a diffraction angle by the phase hologram 3. That is, in case that the central wavelength λ0 and another wavelength having a difference of Δλ,

λ0+Δλ, are incident on the phase hologram having the grating pitch of p, then the maximum diffraction angle direction of the center wavelength is ±arcsine (λ0/(2 p)), whereas a diffraction displacement angle of the wavelength λ0+Δλ is ±Δλ/(2 p).

As a more concrete example of numerical values, for example, given 1.25 μm as the in-plane minimum pattern pitch of the phase hologram, 248.2 nm as the center wavelength, 0.2 nm as the wavelength displacement, and −0.0001 as the refractive index difference, then the diffraction direction angle of light having the wavelength displacement of 0.2 nm is displaced by 0.08 mrad with respect to 99.4 mrad given as the diffraction direction angle of the center wavelength. Thus, in the optical system same as the one shown in FIG. 1, when a telecentric optical system using a lens having a focal length f of 300 mm is used, a displacement of Δx=24 μm is caused on the processing plane as shown in FIG. 13. For ease of explanation, of a plurality of divergent beams of light from the phase hologram, propagation of two wavelengths, the wavelength λ0 and the wavelength λ0+Δλ, for one divergent beam of light is indicated by a dotted line C3 and a solid line C4.

When the band width of the spectral is narrowed by incorporating a wavelength selecting element, such as an etalone or a diffraction grating, into the resonator of the laser oscillation, then the spectral half band width of the laser oscillating wavelength can be approximately 0.001 (±0.0005 nm).

In this case, the difference of the refractive index is reduced to approximately ±0.00000025, and the foregoing displacement caused on the processing plane is reduced to 0.06 μm from 24 μm, thereby substantially eliminating the adverse affect of the chromatic aberration. Also, there can be attained an effect that not only can defocusing of an image at the image forming position be reduced, but also a larger margin is allowed for the focus direction position displacement on the processing plane due to elimination of the chromatic aberration.

The concavo-convex pattern is formed in the depth direction of the surface on the phase hologram 3. However, the concavity and convexity vary from a designed value due to the processing accuracy limit. The adverse affect of such an error appears as a difference from the designed value of the diffraction grating, that is, the occurrence of the zero dimensional light component, which is preferably eliminated from the design, and possibly results in a practically undesired effect. The zero dimensional light referred to herein is a beam of light passing the phase hologram straightforward without changing the outgoing angle at all. Further, in case of the first embodiment, the zero dimensional light component forms a light spot at the center position of the optical axis on the processing plane 101 after passing through the phase hologram with the subsequent optical system. In general, the zero dimensional light spot is formed at the center position with the most popular binary (having the phase difference [symbol] alone; the case of m=2 in the explanation of the principle) phase hologram 3 having the one step of concavity and convexity for the light irradiation pattern (herein, grating-like pattern) formed on the processing plane by the diffraction light other than the zero dimensional light from the phase hologram.

With the phase hologram having two or more steps (m is three or grater) of the concavity and convexity, an a symmetrical light irradiation pattern can be formed. Thus, it can be designed so as not to form the zero dimensional light spot at the center portion, and the irradiation pattern portion by the diffraction light can be spaced apart from the position of the zero dimensional light spot on the processing plane. However, this raises a problem that the cost is increased and the concavo-convex processing demands the higher accuracy. Thus, as to the binary phase hologram, the adverse affect of the zero dimensional light is avoided by the following means.

The zero dimensional light spot gives an irradiation pattern different from the designed irradiation pattern. Thus, in order to irradiate a desired irradiation light pattern on the fiber 1, the placement of the fiber 1 within the processing plane is arranged in the following manner. FIG. 14 is a plan view of the processing plane 101.

For a grating-like irradiation pattern C5 formed by the diffracted light other than the zero dimensional light and a zero dimensional light spot C6, by placing the fibers 1 by displacing the same in the direction perpendicular to the grating axis of the irradiation pattern C5 so as not to superimpose on the light spot C6, light irradiation of a desired shape can be obtained without any adverse affect of the zero dimensional light.

In case of the phase hologram using the synthetic quartz, the phase difference on the surface is formed by a technique called as reactive ion etching. However, the best control accuracy by the current technique in the depth direction is 1 to 2 nm for a spatial depth, and approximately 20 mrad for the phase of 248 nm. Given Ω as a displacement from D of the phase difference, then a ratio of the zero dimensional light transmitting component of the phase hologram can be computed as: (1−cos(Ω))/2. In this case, when consideration is given in terms of a ratio of a light quantity immediately after passing through the phase hologram, the zero dimensional light component can be computed as approximately 0.001%. However, the adverse affect of the light irradiation pattern formed on the processing plane varies considerably depending on the pattern, and there may be a case that the zero dimensional light component reaches a few times greater than the peak value within the pattern.

In case that the original design pattern is not present around the zero dimensional light spot, the allowance level varies depending on the pattern, and there may be a case that the zero dimensional light peak intensity is small but the adverse affect thereof is noticeable. For this reason, the present technique is necessary.

As has been discussed, because the zero dimensional light spot is formed at the center, by irradiating one of the right and left sides from the center of the grating pattern with respect to the grating direction onto the fiber 1, there can be attained a similar effect in terms of performing grating-like irradiation without adverse affect of the zero dimensional light. In this case, means to achieve the foregoing so as to substantially eliminate the adverse affect of irradiation includes: placing a light blocking mask immediately before the processing plane; removing the fiber 1 at the light irradiation portion at either side including the unwanted zero dimensional light spots by bending the same within the processing horizontal plane; bending the fiber 1 in the vertical direction with respect to the processing horizontal plane so as to blur the irradiation light and thereby to reduce irradiation energy density, etc.

If an interval between the diverging point of a beam of light or the light source and the main plane of the lens is identical with the focal length f of the lens, such an optical system is generally called as one side telecentric optical system. The one side telecentric optical system has characteristics that all of the beams of light having passed through the lens become beams of light parallel with the optical axis. A seventeenth embodiment of the invention is adapted to the grating processing unit described in the first embodiment, and as a result, all of the beams of light irradiated onto the work that is perpendicular to the optical axis are incident perpendicularly on the work. In other words, even when the interval between the main plan of the lens and the work varies from the focal length f of the lens, the pitch Λ of the grating-like beams does not vary. By constituting the one side telecentric optical system in the above manner, the resulting grating processing unit can allow such a large margin that the pitch Λ of the grating-like beams does not vary within the focal depth, in which each beam width of the grating-like beams does not vary.

FIG. 15 shows an arrangement of a grating processing unit in accordance with an eighteenth embodiment of the present invention. In the drawing, C7 denotes alight source for observing the transmitting characteristics of the grating, and C8 denotes spectroscope for observing the transmitting characteristics of the grating. By adding the light source C7 and spectroscope C8 to the grating processing unit described in the first embodiment in the above manner, the processing state of the grating can be observed from time to time while the grating is processed. Thus, by adjusting a quantity of light irradiation energy while checking the measuring result, the grating can be processed with even higher accuracy.

As has been discussed, a grating processing unit of the present invention forms a grating-like light intensity pattern through a Fourier transform phase hologram, thereby attaining an effect that accuracy of the grating can be extremely high.

Also, the Fourier transform phase hologram outputs a plurality of beams of outgoing light, thereby attaining an effect that more than one processing portion can be processed simultaneously. Also, different light intensity is set to each of the plurality of beams of outgoing light from the Fourier transform phase hologram, thereby attaining an effect that processing contents of a plurality of processing portions can be set arbitrarily. Also, each angle among the plurality of beams of outgoing light from the Fourier transform phase hologram is equal or different, thereby making it possible to choose whether the chirp effect should be added or not. Also, a position-adjustable single lens or combined lens is used, thereby attaining an effect that the grating cycle can be adjusted minutely by adjusting the position.

Also, the single lens and cylindrical lens are combined or the combined lens and cylindrical lens are combined, thereby attaining an effect that a grating with even higher accuracy can be processed. Also, the combined lens uses an fΘ lens, thereby attaining an effect that a grating with even higher accuracy can be processed.

Also, because the combined lens uses a cylindrical lens placed such that an axial direction of a cylinder is parallel with an axial direction of the processing light wave guide, by changing the magnification of the cylindrical lens, the light intensity can be adjusted independently of the grating cycle, thereby attaining an effect that a plurality of processing fibers can be processed simultaneously.

Also, the combined lens uses a cylindrical lens placed such that an axial direction of a cylinder intersects with an axial direction of the processing light wave guide at right angles, thereby attaining an effect that, by changing the magnification of the cylindrical lens, the grating cycle can be adjusted independently of the light intensity.

Also, because the Fourier transform phase hologram is allowed to rotate in-plane, when the divergence angles of the beams of incident light are different depending on the directions, there can be attained an effect that adjustment can be made in accordance with the beams of incident light. Also, because the Fourier transform phase hologram can output beams of outgoing light having different grating cycles in a plurality of different directions, it is possible to process the gratings having different grating cycles at more than one arbitrary position simultaneously.

Also, because the outgoing light from the Fourier transform phase hologram is added up so that it is uniform at the processing portion, a larger margin is allowed for the fiber set position error, thereby making it possible to process more than one fiber simultaneously.

A KrF or ArF excimer laser is used, thereby attaining an effect that efficient and highly accurate processing can be achieved. Also, because a carbon dioxide laser is used, it is possible to produce a refractive index grating of a stress relaxing type.

Also, light beam adjusting means is provided between the light source and Fourier transform phase hologram, thereby attaining an effect that a refractive index distribution of each comb of the grating can be readily formed in a desired shape.

Also, because an intensity distributing mask is used as the light beam adjusting means, it can be formed at a low cost. Also, because a method of modifying a resonator in a laser oscillator serving as a light source is used as the light beam adjusting means, the arrangement of the unit can be simplified. Also, because an aperture is provided between the light source and Fourier transform phase hologram as the light beam adjusting means, the unit can be formed at a low cost. Also, because the position of a processing plane in an optical axis direction is displaced from a focal position as the light beam adjusting means, the unit can be formed at a low cost.

Also, because a spectral band width narrowing device is added to the laser oscillator serving as the light source, it is possible to further upgrade the processing accuracy. Also, because the position of the processing optical fiber is displaced from a center of an optical axis to a position in a direction that intersects with the axis of the optical fiber at right angles, thereby upgrading the processing accuracy. Also, because the position of the processing optical fiber is displaced to outside of a center of a beam irradiation area, the processing accuracy is upgraded.

Also, because an interval between the Fourier transform phase hologram and lens is made equal to a focal length of the lens, a parallel degree of processing light is increased, thereby upgrading the processing accuracy. Also, because a light source connected to one end of the optical fiber and a spectroscope that is connected to the other end of the optical fiber and measures transmitting characteristics of a grating processed onto the optical fiber are additionally provided, it is possible to adjust the light intensity while applying the processing, thereby making it possible to process a grating with even higher accuracy.

Industrial Applicability

As has been discussed, the grating processing unit of the present invention is useful in processing a refractive index grating of an optical device (wave guide grating, fiber grating), and suitable to a grating processing method with the accuracy of the grating cycle Λ ranging approximately from 25 to 1 (nm), and a grating processing method capable of readily changing the grating cycle Λ.

1. A grating processing unit for forming a refractive index diffraction grating on a light wave guide, having a light wave guide portion using a material that causes a change of a refractive index by means of light irradiation, by irradiating irradiation light having a grating-like light intensity pattern, characterized by including:
a light source; and
an optical system for generating the irradiation light having said grating-like light intensity pattern out of light emitted from said light source through a Fourier transform phase hologram.

2. The grating processing unit according to claim 1, wherein said light wave guide is an optical fiber having a core portion using the material that causes a change of the refractive index by means of light irradiation.

3. The grating processing unit according to claim 1, wherein said optical system includes:
a Fourier transform phase hologram having a function of diverging light emitted from said light source into a plurality of beams of outgoing light at an arbitrary predetermined angle; and
a lens for forming an image of said plurality of beams of outgoing light from said Fourier transform phase hologram on said light wave guide.

4. The grating processing unit according to claim 3, wherein said Fourier transform phase hologram gives different intensity to each of said plurality of divergent beams of outgoing light.

5. The grating processing unit according to claim 3, wherein said Fourier transform phase hologram makes each angle among said plurality of beams of outgoing light equal.

6. The grating processing unit according to claim 3, wherein said Fourier transform phase hologram makes each angle among said plurality of beams of outgoing light different.

7. The grating processing unit according to claim 3, wherein said lens is a single lens provided between said Fourier transform phase hologram and light wave guide such that a position thereof is adjustable.

8. The grating processing unit according to claim 3, wherein said lens is composed of a single lens and a cylindrical lens provided between said Fourier transform phase hologram and light wave guide such that a position thereof is adjustable.

9. The grating processing unit according to claim 8, wherein an axial direction of a cylinder of said cylindrical lens is parallel with an axial direction of said light wave guide.

10. The grating processing unit according to claim 8, wherein an axial direction of a cylinder of said cylindrical lens intersects with an axial direction of said light wave guide at right angles and intersects with a line linking said light source and light wave guide at right angles.

11. The grating processing unit according to claim 3, wherein said lens is a combined lens provided between said Fourier transform phase hologram and light wave guide and combined such that a focal length thereof is adjustable.

12. The grating processing unit according to claim 11, wherein said combined lens is an fΘ lens arranged in such a manner that an incidence angle on said combined lens and an image position correspond linearly.

13. The grating processing unit according to claim 11, wherein said combined lens has a cylindrical lens, and an axial direction of a cylinder of said cylindrical lens is parallel with an axial direction of said light wave guide.

14. The grating processing unit according to claim 11, wherein said combined lens has a cylindrical lens, and an axial direction of a cylinder of said cylindrical lens intersects with an axial direction of said light wave guide at right angles and intersects with a line linking said light source and light wave guide at right angles.

15. The grating processing unit according to claim 1, wherein said Fourier transform phase hologram includes a rolling mechanism that is fixable at an arbitrary angle in-plane in said Fourier transform phase hologram.

16. The grating processing unit according to claim 1, wherein said Fourier transform phase hologram outputs beams of outgoing light having an arbitrary grating cycle in a plurality of different directions.

17. The grating processing unit according to claim 1, wherein a pattern and a focal length of a lens of said Fourier transform phase hologram are determined in such a manner that divergent beams of outgoing light from said Fourier transform phase hologram have a uniform intensity distribution in a direction that intersects with a line linking said light source and light wave guide at right angles at a grating processing portion.

18. The grating processing unit according to claim 1, wherein said light source is a KrF excimer laser or an ArF excimer laser.

19. The grating processing unit according to claim 1, wherein said light source is a carbon dioxide laser.

20. The grating processing unit according to claim 1, further including light beam adjusting means, provided between said light source and Fourier transform phase hologram, for adjusting a beam of light emitted from said light source into a shape that is determined by applying inverse Fourier transform to Fourier transform characteristics of said optical system.

21. The grating processing unit according to claim 20, wherein said light beam adjusting means uses a phase modulating element inserted between said light source and Fourier transform phase hologram.

22. The grating processing unit according to claim 20, wherein said light beam adjusting means uses, as a light source, a laser oscillator, in which a resonator is modified so that a desired light beam distribution is obtained.

23. The grating processing unit according to claim 20, wherein said light beam adjusting means is an aperture provided between said light source and Fourier transform phase hologram.

24. The grating processing unit according to claim 20, wherein said light beam adjusting means adjusts the Fourier transform characteristics of said optical system by displacing a position of said light wave guide forward or backward from an image forming position along an optical axis.

25. The grating processing unit according to claim 18, wherein said laser oscillator as said light source is additionally provided with a spectral band width narrowing device, so that wavelength purity of said light source is upgraded.

26. The grating processing unit according to claim 2, wherein said optical fiber is displaced from a center position of an optical axis of the irradiation light to a position in a direction that intersects with a longitudinal direction of said optical fiber at right angles and intersects with the optical axis of the irradiation light at right angles.

27. The grating processing unit according to claim 2, wherein said optical fiber is placed only at one side of a beam irradiation area from a center thereof.

28. The grating processing unit according to claim 3, wherein an interval between said Fourier transform phase hologram and lens is made equal to a focal length of said lens.

29. The grating processing unit according to claim 2, wherein said optical fiber includes:
a light source connected to one end of said optical fiber; and
a spectroscope, connected to the other end of said optical fiber, for measuring transmitting characteristics of a grating processed onto said optical fiber.
